(19) United States
(12) Patent Application Publication
(10) Pub. No.: US 2014/0238377 A1
(43) Pub. Date: Aug. 28, 2014

(54) Simple Camp Grill

(71) Applicants: Mark P. Moore, Weatherford, TX (US); Lloyd McCall, Monahans, TX (US)

(72) Inventors: Mark P. Moore, Weatherford, TX (US); Lloyd McCall, Monahans, TX (US)

(21) Appl. No.: 13/778,424

(22) Filed: Feb. 27, 2013

(51) Int. Cl. A47J 33/00; B21D 53/02

(52) U.S. Cl. CPC A47J 33/00; B21D 53/02
USPC 126/30; 29/890.045; 29/460

(57) ABSTRACT

A simple grill comprised of a body made from a circular section of seamless metal. The grill consists of an open top and an open bottom, with the grill used by placing vertically on a surface with the open bottom in contact with the surface. A support structure is welded proximate to the open top to support a sub-component, typically comprising a gridiron. Fuel placed though an opening in the side of the body in contact with the surface burns to provide heat for cooking. Two handles welded to the outer side of the body facilitate removing the grill after use, with the ash residue left in place.

### BACKGROUND

The present application relates to a simple camp grill design, and more particularly to a camp grill constructed from seamless metal tubing or pipe.

Camp grills and backyard grills typically consist of a number of sub-components assembled together. These grills typically require manual assembly after purchase or before use by mating the various subcomponents using conventional fasteners such as nuts, bolts, and screws. Camp grills more specifically feature lightweight construction of sheet metal, and a structure that lends itself to breakdown into the various subcomponents for transport in a backpack or similar camping transport. Backyard grills, while usually made of heavier sheet metal and more robust construction, likewise use various subcomponents held together with fasteners. More substantial grills can also be found made from 55-gallon drums and the like with subcomponents that likewise require fasteners.

Virtually all currently available grills use an enclosed bottom design. These prior art grill designs hold fuel in an enclosed bottom to burn so as to provide heat and flame for cooking and comfort in cool weather. Such a grill, however, must be manually cleaned with the spent fuel ash residue dumped into a receptacle or emptied onto the ground.

### SUMMARY

The present application discloses a simple grill with an open bottom and modular subcomponents not requiring fasteners.

In some embodiments, the inventions include a seamless, circular metal body that supports at least one subcomponent.

The disclosed innovations, in various embodiments, provide one or more of at least the following advantages. However, not all of these advantages result from every one of the innovations disclosed, and this list of advantages does not limit the various claimed inventions.
Lower construction costs.
Simplicity of design and use.
No assembly of parts using fasteners.
Ruggedness.
Ease of handling ash waste.
Ease of cleaning after use.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 depicts a perspective view of an exemplary grill body.

FIG. 2 depicts a downward looking view of the exemplary grill body of FIG. 1.

FIG. 3 depicts a perspective view of an exemplary grill with an exemplary gridiron installed on the grill.

FIG. 4 depicts a downward view of the exemplary grill with the gridiron installed of FIG. 3.

FIG. 5 depicts a side view of the exemplary grill of FIG. 1 showing how the exemplary gridiron fits onto the exemplary grill.

FIG. 6 depicts a side view of FIG. 5 with the exemplary gridiron in place.

FIG. 7 depicts a perspective view of the exemplary grill of FIG. 1 showing how an exemplary griddle fits onto the top of an exemplary grill.

FIG. 8 depicts the perspective view of FIG. 7 with the exemplary griddle in place.

FIG. 9 depicts a flow chart of a method for producing an exemplary grill.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

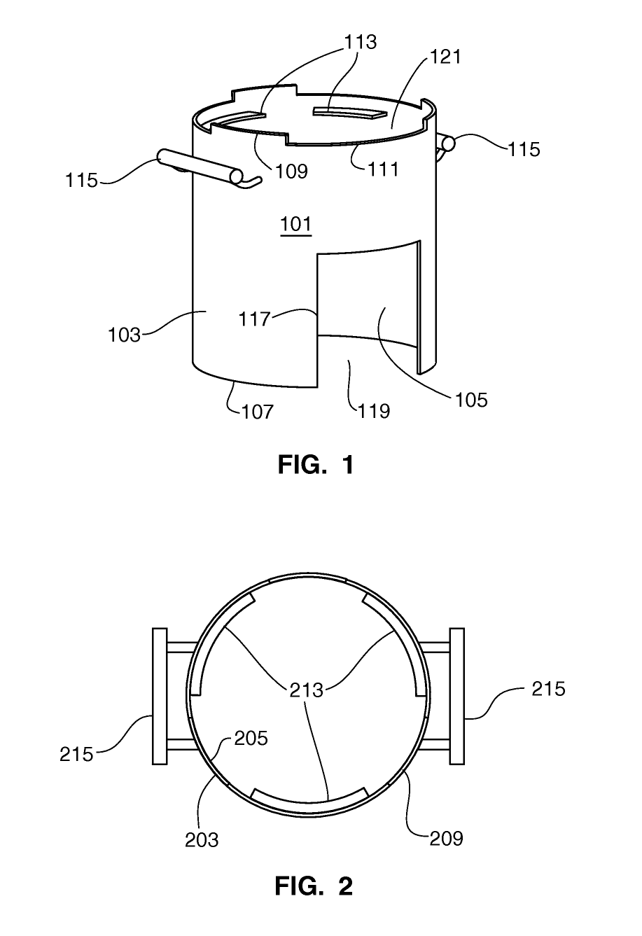

FIG. 1 depicts a sample embodiment of a grill body of the inventions. As depicted, a cylindrical seamless section of metal, such as, for example, a section of metal tubing or pipe forms the exemplary grill body 101. The metal used is typically either iron, steel, or an alloy thereof, but other types of metal or alloys with high melting points can be used. Preferably, the grill body 101 comprises a section of metal pipe of at least 1/16″ thickness or otherwise made from heavy gauge metal, with the metal comprising, for example, iron, steel, or an alloy thereof. As depicted, exemplary grill body 101 comprises an outer side 103 and an inner side 105. The outer side 103 and inner side 105 forms a bottom edge 107 at the portion of the grill body 101 in contact with the ground, and a top edge 109 at the portion of the grill body 101 not in contact with the ground and opposite from bottom edge 107. As shown, at least one opening is located proximate to the top edge 109 to promote draw through the grill body 101. As depicted, parallel slot 111, and preferably a series of parallel slots 111, is cut parallel and into the top edge 109 to provide a draw of air through the grill body 101. Alternatively, instead of parallel slots 111, a series of vertical slits can be cut into the top edge 109, or one or more openings can be cut below and proximate to the top edge 109.

As depicted, proximate to the top edge 109, a support structure 113 positioned below the top edge 109 attaches in place. The support structure 113 is positioned and attached to receive and support a subcomponent inserted from the top edge 109. The support structure 113 can be formed from lengths of metal welded to the inner side 105, a continuous band of metal spot welded to the inner side 105, hooks welded to inner side 105, or some other appurtenance attached to the inner side 105 to engage and support a subcomponent.

As depicted, on the outer side 103, two handles 115 attach, preferably welded in place, to permit a user to move the grill body 101. The handles 115 can be insulated from heat or can be left as bear metal. Preferably, the handles 115 are insulated by a heat resistant material that can comprise, for example, a wooden grip, leather grip, heat resistant plastic or acrylic grip, or some other heat resistant material. Alternatively, it is self evident, that rather than welding, the support structure 113 and handles 115 can be attached using fasteners, such as, for example, nuts, bolts, screws, and the like.

As depicted, the exemplary grill body 101 also includes an opening 117 through which fuel can be added to the grill body 101, such as, for example, wood, coal, charcoal, or briquettes. Any combustible material, in theory, can be used. The opening 117 can also comprise a portal (not depicted) to close over the opening 117 to restrict air draw or loss of heat. Additionally, the opening 117 can be offset from the bottom edge 107, so that the bottom edge 107 is continuous and unbroken. Also, the grill body 101 as depicted possesses an open bottom 119 and an open top 121. The grill body 101 rests vertically on the bottom edge 107 when in use, with the open bottom 119 opening directly upon the ground in normal use.

FIG. 2 depicts a downward view of the exemplary grill body 101 in FIG. 1. As depicted, between the outer side 203 and inner side 205 is top edge 209. A recessed support structure 213 is designed to receive and support a cooking surface subcomponent and is welded or otherwise attached in place to the inner side 205. As depicted, welded or otherwise attached to the outer side 203 are two handles 215. Alternatively, the support structure 213 and handles 215 can be attached using fasteners rather than by welding.

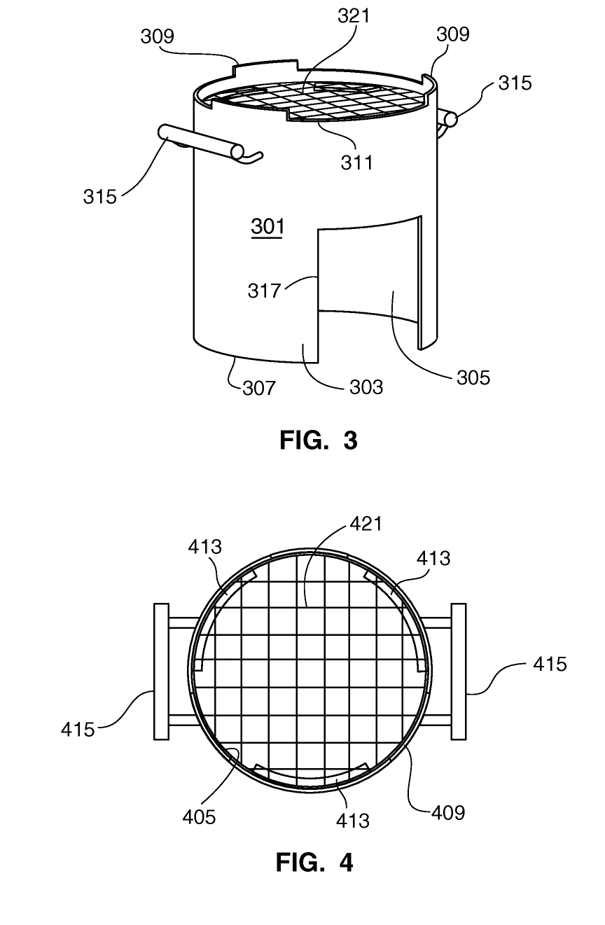

FIG. 3 depicts a perspective view of the exemplary grill body 101 of FIG. 1 with an exemplary gridiron installed on the grill. As depicted, cylindrical seamless section of metal forms the exemplary grill body 301. The exemplary grill body 301 comprises an outer side 303 and an inner side 305. The outer side 303 and inner side 305 forms a bottom edge 307 at the portion of the grill body 301 in contact with the ground, and a top edge 309 at the portion of the grill body 301 not in contact with the ground. As depicted, at least one parallel slot 311, and preferably a series of parallel slots 311, is cut parallel to and into the top edge 309 to promote draw of air through grill body 301 from opening 317. Alternatively, instead of parallel slots 311, a series of vertical slits can be cut into the top edge 309.

Referring to FIG. 1, proximate to the top edge 309 is a recessed support structure 113 designed to receive a subcomponent comprising a cooking surface. As depicted, the subcomponent comprises a gridiron 321 that fits down below the top edge 309 to rest upon the recessed support structure 113. On the outer side 303, two handles 315 are welded in place to permit a user to move the grill body 301. As depicted, the exemplary grill body 301 also includes an opening 317 through which fuel can be added to the grill body 301.

FIG. 4 depicts a downward view of the exemplary grill body 301 with the installed gridiron of FIG. 3. As depicted, the grill body 301 comprises the outer side 403 and inner side 405 with a top edge 409 between the outer side 403 and inner side 405. The recessed support structure 413 is designed to receive and support a cooking surface and is welded in place to the inner side 405. As depicted, gridiron 421 fits within the grill body 301 below top edge 409 to fit upon support structure 413. The gridiron 421 comprises stainless steel, steel, iron, or alloys thereof. Attached to the outer side 403 are two handles 415.

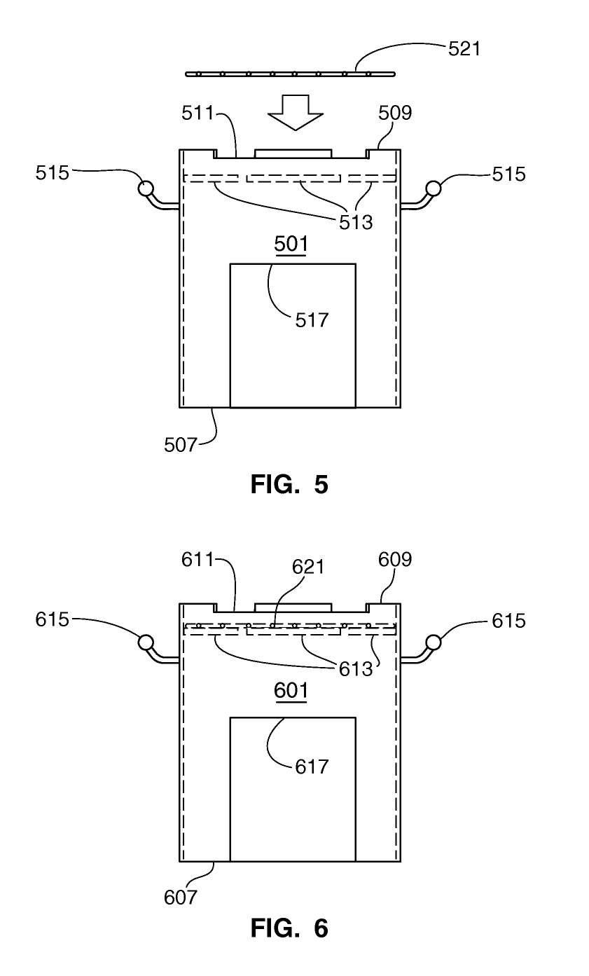

FIG. 5 depicts a side view of the exemplary grill of FIG. 1 showing how the exemplary gridiron fits onto the exemplary grill. As depicted, trill body 501 comprises a bottom edge 507 at the portion of the grill body 501 in contact with the ground, and a top edge 509 at the portion of the grill body 501 not in contact with the ground. As depicted, at least one parallel slot 311, and preferably a series of parallel slots 511, is cut parallel and into the top edge 509 to promote draw of air through grill body 501. Alternatively, instead of parallel slots 511, a series of vertical slits can be cut into the top edge 509.

As depicted, proximate to the top edge 509 is a support structure 513 positioned below the top edge 509 on the inside of the grill body 501. The support structure 513 is designed to receive gridiron 521 and support it over a fire or hot coals inside the grill body 501. Gridiron 521 can also include a handle (not shown) to facilitate positioning onto the grill body 501. As depicted, two handles 515 are welded in place to grill body 501 to permit a user to move the grill body 501. The exemplary grill body 501 also includes an opening 517 through which fuel can be added to the grill body, such as, for example wood, coal, charcoal, or briquettes. The opening 517 can also comprise a portal (not depicted) to close over the opening 517.

FIG. 6 depicts a side view of the exemplary grill of FIG. 5 showing the exemplary gridiron fitted in place. As depicted, grill body 601 comprises a bottom edge 607 and a top edge 609. At least one parallel slot 611, and preferably a series of parallel slots 611, is cut parallel and into the top edge 609 to promote draw of air through grill body 601. Alternatively, instead of parallel slots 611, a series of vertical slits can be cut into the top edge 609.

As depicted, proximate to the top edge 609 is a support structure 613 positioned below the top edge 609 on the inside of the grill body 601. As depicted, the gridiron 621 has been placed within the grill body 601 and fits onto support structure 613. The support structure 613 supports the gridiron 621 over a fire or hot coals inside the grill body 601. Two handles 615 are welded in place to permit a user to move the grill body 601. The exemplary grill body 601 also includes an opening 617 through which fuel can be added to the grill body 601, such as, for example wood, coal, charcoal, briquettes, or the like. The opening 617 can also comprise a portal (not depicted) to close over the opening 617.

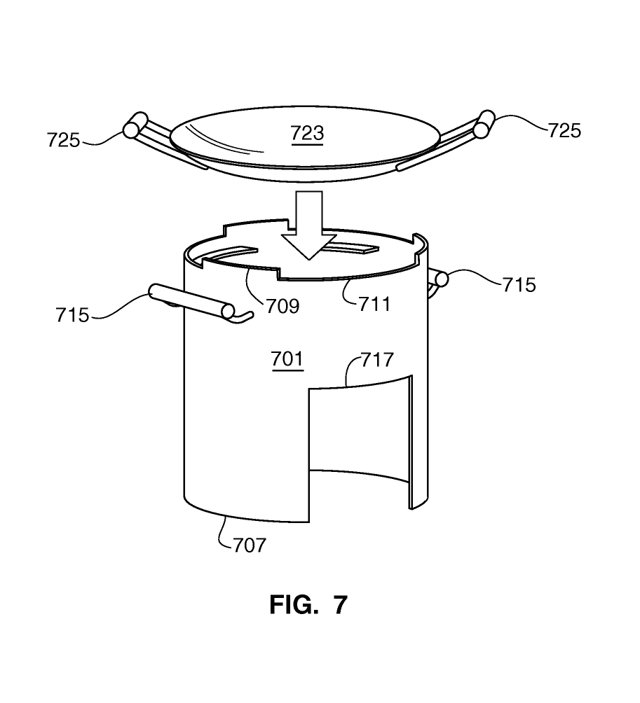

FIG. 7 depicts a perspective view of the exemplary grill of FIG. 1 showing how an exemplary griddle fits onto the exemplary grill. As depicted, grill body 701 comprises a bottom edge 707, a top edge 709, and an opening 717 to receive fuel. As depicted, at least one parallel slot 711, and preferably a series of parallel slots 711, is cut parallel and into the top edge 709 to promote draw of air through grill body 701. Griddle 723, as depicted, comprises a flat or substantially flat surface constructed from a circular section of metal such as stainless steel, copper, steel, iron, or alloys thereof. The metal can be formed from thin sheet metal or a thicker gauge of metal. Griddle 723 fits onto top edge 709 and can include dimples or some other appurtenance (not shown) on the underside of griddle 723 to help hold griddle 723 in place on the grill body 701. Also, the griddle 723 can possess a shallow concave shape to fit within the grill body 701 to help hold it in place on the grill body 701. As depicted, the griddle 723 also comprises two handles 725.

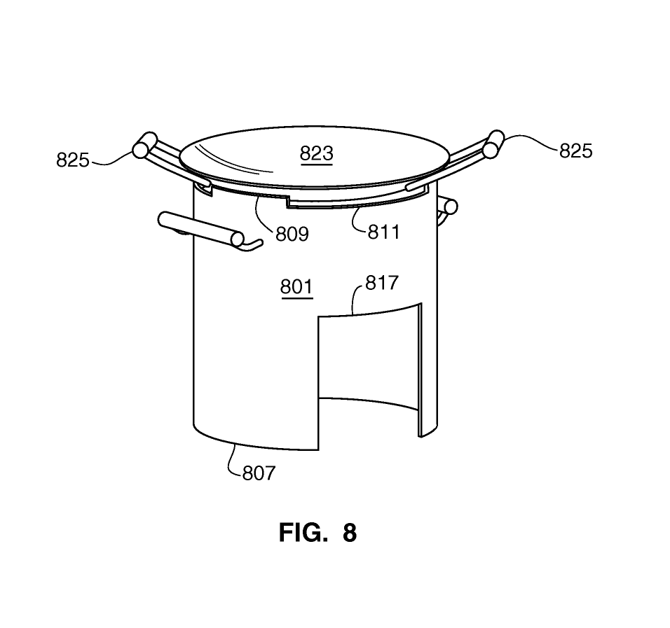

FIG. 8 depicts the perspective view of FIG. 7 with the exemplary griddle in place. As depicted, grill body 801 comprises a bottom edge 807, a top edge 809, and an opening 817 to receive fuel. At least one parallel slot 811, and preferably a series of parallel slots 811, is cut parallel and into the top edge 809 to promote draw of air through grill body 801. As depicted, griddle 823 rests on top edge 809 and can include dimples or some other appurtenance on the underside of griddle 823 to help hold griddle 823 on the grill body 801. Also, the griddle 823 can possess a shallow concave shape to fit within the grill body 801. The griddle 823 also comprises two handles 825.

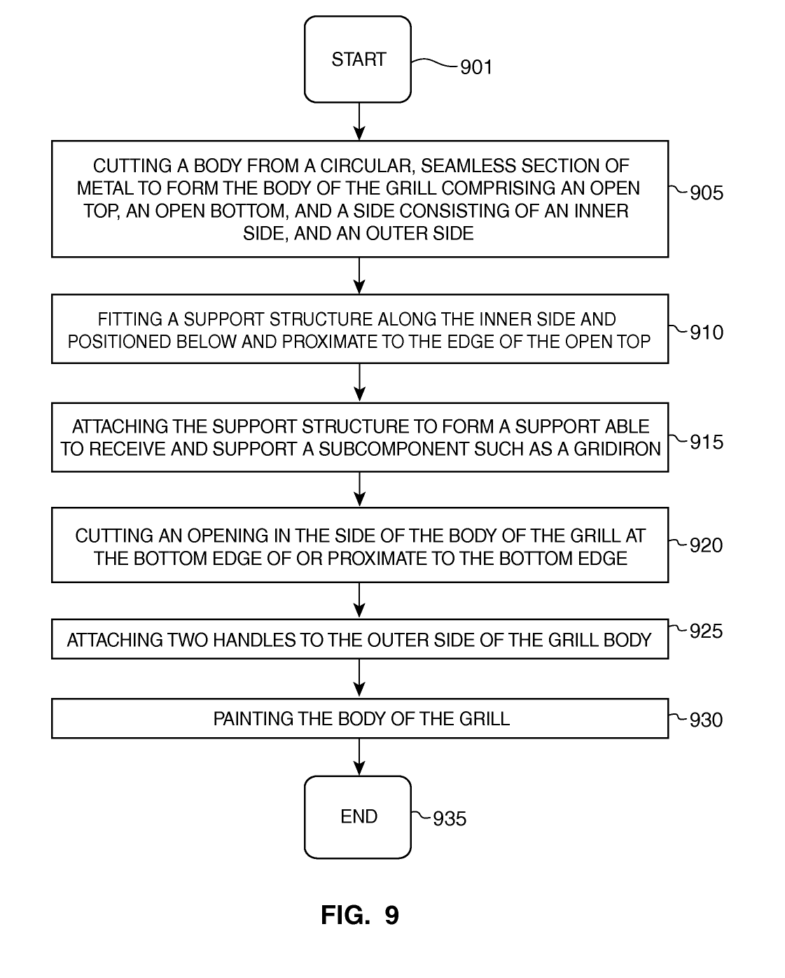

FIG. 9 depicts an exemplary flow chart of a method for producing an exemplary grill. The method starts at step 901. In step 905, the method comprises cutting a body from a circular, seamless section of metal to form the body of the grill, which comprises an open top, an open bottom, and a side consisting of an inner side, and an outer side. At step 910, the method includes fitting a support structure along the inner side positioned below and proximate to the edge of the open top. In step 915, the method comprises attaching the support structure to form a support able to receive and support a subcomponent such as a gridiron. Preferably, welding attaches the support structure in place, but alternatively, fasteners attach the support structure in place. The method in step 920 comprises cutting an opening in the side of the grill body at the bottom edge of or proximate to the open bottom. At step 925, the method includes welding two handles to the outer side of the grill body, and in step 930, the method includes painting the grill body. Alternatively, the handles can be attached using fasteners. At step 935, the method ends.

The foregoing has described a grill and method for making a grill that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

According to various embodiments, there is provided: A grill for heating or cooking, comprising: a body made from a section of seamless metal consisting of an open top, an open bottom, an inner side, and an outer side, wherein when in use the body is placed vertically on a surface with the open bottom in contact with the surface; a support structure attached to the inner side and positioned proximate to a top edge of the open top and able to support a sub-component; and an opening in the side of the body proximate to the open bottom to receive fuel.

According to various embodiments, there is provided: A grill designed to be placed on the ground with fuel burned on the ground inside the grill to provide cooking heating, comprising: a circular structure constructed from a seamless section of metal consisting of a circle of heavy gauge metal comprised of an open top that opens directly vertically, an open bottom that opens directly vertically onto the ground so that fuel placed into the grill body makes direct contact with the ground, an inner side, an outer side, a top edge, and a bottom edge, the grill intended to operate with the bottom edge resting on the ground; a support structure fitted along and welded to the inner side and positioned proximate to the open top and offset below the top edge and able to support a subcomponent; an opening though the inner side and the outer side proximate to the open bottom; and two handles welded to the outer side of the body.

According to various embodiments, there is provided: A method for constructing a grill, comprising the steps of: cutting a body from a circular seamless section of metal to form the body of the grill comprising an open top, an open bottom, an inner side, and an outer side; fitting a support structure along the inner side positioned below and proximate to the edge of the open top; and attaching the support structure to form a support able to receive and support a subcomponent.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The idea of a seamless section of metal tubing can be further ascribed to a cross-sectional portion of a 55-gallon drum. Claims for seamless metal tubing or seamless metal extend to a section of a 55-gallon drum or similar circular sections of metal.

In some contemplated embodiments, the body of the grill can be constructed from sections of discarded well stem pipe or pipelines condemned because of metal fatigue or corrosion. After appropriate cleaning and preparation, such pipe can be recycled by sectioning and constructing into a grill as described.

The contemplated preferred size of an exemplary embodiment of the grill body is between 8″ and 36″ in diameter and between 6″ and 30″ tall. However, larger or smaller sizes can be utilized.

Although the disclosed preferred embodiment uses a circular body, it is readily appreciated that the body can be made from other shapes of metal.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A grill for heating or cooking, comprising:
a body made from a section of seamless metal consisting of an open top, an open bottom, an inner side, and an outer side, wherein when in use the body is placed vertically on a surface with the open bottom in contact with the surface;
a support structure attached to the inner side and positioned proximate to a top edge of the open top and able to support a subcomponent; and
an opening in the side of the body proximate to the open bottom to receive fuel.

2. The grill for heating or cooking of claim 1, further comprising:
at least one opening to promote draw proximate to or in the top edge.

3. The grill for heating or cooking of claim 2, further comprising:
a series of slots or slits in the top edge.

4. The grill for heating or cooking of claim 1, wherein the support structure comprises a circular band of metal welded to the inner side.

5. The grill for heating or cooking of claim 1, wherein the support structure comprises pieces of metal welded to the inner side.

6. The grill for heating or cooking of claim 1, wherein the grill body includes a portal for closing the opening on the side.

7. The grill for heating or cooking of claim 1, wherein the subcomponent comprises a gridiron.

8. A grill designed to be placed on the ground with fuel burned on the ground inside the grill to provide cooking heating, comprising:
a circular structure constructed from a seamless section of metal consisting of a circle of heavy gauge metal comprised of an open top that opens directly vertically, an open bottom that opens directly vertically onto the ground so that fuel placed into the grill body makes direct contact with the ground, an inner side, an outer side, a top edge, and a bottom edge, the grill intended to operate with the bottom edge resting on the ground;
a support structure fitted along and welded to the inner side and positioned proximate to the open top and offset below the top edge and able to support a subcomponent;
an opening though the inner side and the outer side proximate to the open bottom; and
two handles welded to the outer side of the body.

9. The grill of claim 8, further comprising:
at least one opening to promote draw proximate to or in the top edge.

10. The grill for heating or cooking of claim 9, further comprising:
a series of slots or slits in the top edge.

11. The grill of claim 8, wherein the support structure comprises a circular band of metal.

12. The grill of claim 8, wherein the support structure comprises pieces of metal.

13. The grill of claim 8, wherein the body includes a portal for closing the opening on the side.

14. The grill of claim 8, wherein the subcomponent comprises a gridiron.

15. The grill of claim 8, further comprising:
a griddle fitted to the top of the grill body.

16. A method for constructing a grill, comprising the steps of:
cutting a body from a circular seamless section of metal to form the body of the grill comprising an open top, an open bottom, an inner side, and an outer side;
fitting a support structure along the inner side positioned below and proximate to an edge of the open top; and
attaching the support structure to form a support able to receive and support a subcomponent.

17. The method of claim 16, further comprising the step of:
cutting an opening in the side of the body of the grill at the bottom edge or proximate to the bottom edge.

18. The method of claim 17, wherein the body includes a portal for closing the opening on the side.

19. The method claim 16, further comprising the step of:
painting the body of the grill.

20. The method of claim 16, wherein the subcomponent comprises a gridiron.
